(19) United States
(12) Patent Application Publication
(10) Pub. No.: US 2013/0232090 A1
(43) Pub. Date: Sep. 5, 2013

(54) Systems and Methods for Providing Direct to Capital Swaps

(71) Applicant: BARCLAYS CAPITAL INC., New York, NY (US)

(72) Inventors: Walter Greer Maloney, Summit, NJ (US); Amit Manwani, New York, NY (US)

(73) Assignee: Barclays Capital Inc., New York, NY (US)

(21) Appl. No.: 13/861,828

(22) Filed: Apr. 12, 2013

Related U.S. Application Data
(63) Continuation of application No. 13/287,716, filed on Nov. 2, 2011, now abandoned.
Application No. 13/287,716 is a continuation of application No. 12/126,276, filed on May 23, 2008, now abandoned.
(60) Provisional application No. 60/940,291, filed on May 25, 2007.

(51) Int. Cl. G06Q 40/06

(52) U.S. Cl. CPC G06Q 40/06
USPC 705/36 R

(57) ABSTRACT

In one aspect, the present invention comprises a computer system for market making, comprising: (a) a computer component for receiving data identifying a user-specified basket of securities; (b) a database storing the data identifying a user-specified basket of securities and storing data describing inventory of a market maker; and (c) a computer component for calculating a swap price for the basket in light of the inventory, the calculating based at least in part on quote deflection related to the inventory. Other aspects comprise related methods and software.

### CROSS-REFERENCE TO RELATED APPLICATIONS

This application is a continuation of U.S. patent application Ser. No. 13/287,716 filed Nov. 2, 2011, which is a continuation of U.S. patent application Ser. No. 12/126,276 filed May 23, 2008, which claims priority to U.S. Provisional Application No. 60/940,291 filed May 25, 2007, all of which are incorporated herein by reference in their entireties.

### INTRODUCTION

In an equity swap, two parties make a series of payments to each other with at least one set of payments determined by a stock or index return. The other set of payments can be a fixed or floating rate or the return on another stock or index. Equity swaps are used to substitute for a direct transaction in stock.

Synthetic equity mimics conventional financial instruments that may or may not be available to investors. It typically is a combination of financial instruments producing a market instrument with different characteristics (e.g., higher yield, better liquidity, or interest rate protection) than could otherwise be achieved by a corresponding conventional security.

A market maker is a brokerage or bank that maintains a firm bid and ask price in a given security by standing ready, willing, and able to buy or sell at publicly quoted prices (called making a market). These firms display bid and offer prices for specific numbers of specific securities, and if these prices are met, they will immediately buy for or sell from their own accounts.

The technology described herein provides for automated market making—in particular on (but not limited to) synthetic equity swaps. In an embodiment, a client may use a graphic interface to create a custom portfolio (basket) to act as a hedge to their investment portfolio. The client may also work with a synthetics trading desk to create this basket. Once created, the basket will be loaded into a trading system, and the level of the basket will be calculated. A quote may be published that, for example, will represent the level at which a party will enter into a 1 year total return swap on $10 million notional of the underlying basket.

In the past, such swaps have all been marked manually, by using a spreadsheet-based pricing application, and the models used have not taken into account the inventory levels of the business. The processing environment has been manually intensive—clients must execute the trade using the phone, and a sales team manually enters the trade tickets into books and records.

In contrast, embodiments of the present invention comprise systems, methods, and computer-implemented software that makes markets on the swaps in an automated (i.e., computer-implemented) fashion, preferably by deflecting quotes based on inventory levels.

In one aspect, the present invention comprises a computer system for market making, comprising: (a) a computer component for receiving data identifying a user-specified basket of securities; (b) a database storing the data identifying a user-specified basket of securities and storing data describing inventory of a market maker; and (c) a computer component for calculating a swap price for the basket in light of the inventory, the calculating based at least in part on quote deflection related to the inventory.

In certain embodiments: (1) a system as described above further comprises a computer component in communication with an electronic swap trading system; (2) the computer component for calculating a swap price is further operable to calculate a spread associated with the swap price; (3) the spread changes based at least in part on changes in the inventory; (4) the swap price is based at least in part on a sum of a cost component and a product of a risk component and a risk aversion parameter; (5) the cost component corresponds to a cost of unwinding a swap of the basket in a market; (6) the risk component corresponds to risk of maintaining a position in the inventory; (7) the cost component is estimated using a market impact model; (8) the cost component is calculated based at least in part on volatility of the inventory; (9) the price and spread are calculated based at least in part on a correlation between the inventory and the basket; (10) the price and spread are calculated based at least in part on downward shift in effective inventory; (11) the price and spread are calculated based at least in part on alpha adjustment; (12) the alpha adjustment is based at least in part on a trader's performance; (13) the alpha adjustment is directional; (14) the alpha adjustment is proportional to a horizon; (15) the price and spread are calculated based at least in part on a skew ratio; (16) the price and spread are calculated based at least in part on an allowed residual inventory risk level; (17) the price and spread are calculated based at least in part on a crossing effect; (18) the price and spread are calculated based at least in part on a risk pooling effect; (19) the price and spread are calculated based at least in part on an impact convexity effect; (20) the price and spread are calculated based at least in part on a risk boundary effect; (21) the price and spread are calculated based at least in part on a liquidity boundary effect; and (22) the price and spread are calculated based at least in part on a trade flow modulation effect.

In another embodiment, the computer component for calculating a swap price is further operable to calculate the price and spread based at least in part on: (a) adjusting a new swap basket due to crossing; (b) adjusting a risk aversion ratio due to inventory risk skew; (c) pricing the swap on a stand-alone-basis; and (d) adjusting a price of the swap based on the inventory.

In another embodiment, the computer component for calculating a swap price is further operable to calculate the price and spread based at least in part on: (a) pricing a swap on a stand-alone basis; (b) a replication model; and (c) a hedging model. Further, the replication model can (optionally) model replicating an equity swap basket and comprise: (a) buying or selling a number of shares in the basket, and (b) determining an optimal trading trajectory to achieve a minimum cost. In other embodiments: (1) the replication model is based on market impact, replication risk, and risk aversion; (2) the hedging model is a two-phase hedging model; and (3) the two-phase hedging model is based on a transit hedge.

Other aspects and embodiments comprise related methods and software.

### BRIEF DESCRIPTION OF THE DRAWINGS

FIG. 1 depicts a first system embodiment.

FIG. 2 depicts a second system embodiment.

FIG. 3 depicts a third system embodiment.

FIG. 4 depicts a data and order entry screen used in an embodiment.

FIG. 5 illustrates a risk aversion parameter.

FIGS. 6A-10C depict spreadsheets illustrating calculations used in embodiments.

### DETAILED DESCRIPTION OF ONE OR MORE EMBODIMENTS

An embodiment implements a pricing model that prices a basket in the presence of inventory. Aspects also may include a straight-through processing environment that connects client facing systems with inventory control systems, a pricing service, an auto-trader for hedging, and a trade booking system.

The benefits of an embodiment may be realized by both clients and a firm. First, clients will be able to trade custom hedges from an execution management system (“EMS”) as if those hedges were a liquid product. Clients get the speed and efficiency of electronic trading, with the benefit of a market maker's capital. Custom baskets allow clients to complete effective, efficient hedges that permit them to isolate the alpha they believe they create in their portfolios.

From a firm's perspective, there is a substantial gain in efficiency from using such an embodiment. Traders are freed from manually interacting with a pricing spreadsheet, sales personnel don't have to enter the orders, and capital risk usage is more efficient since (preferably) pricing is done in the presence of inventory. The process creates a tremendous amount of scale for the business as well. Given an electronic distribution platform and a straight-through processing environment, much more throughput can be processed with the same amount of resources.

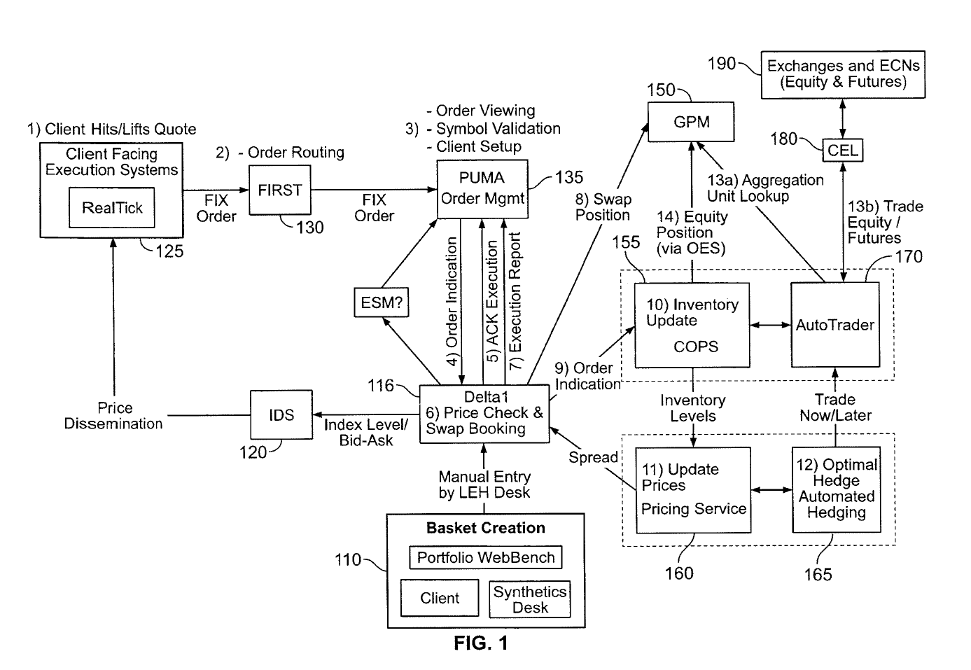

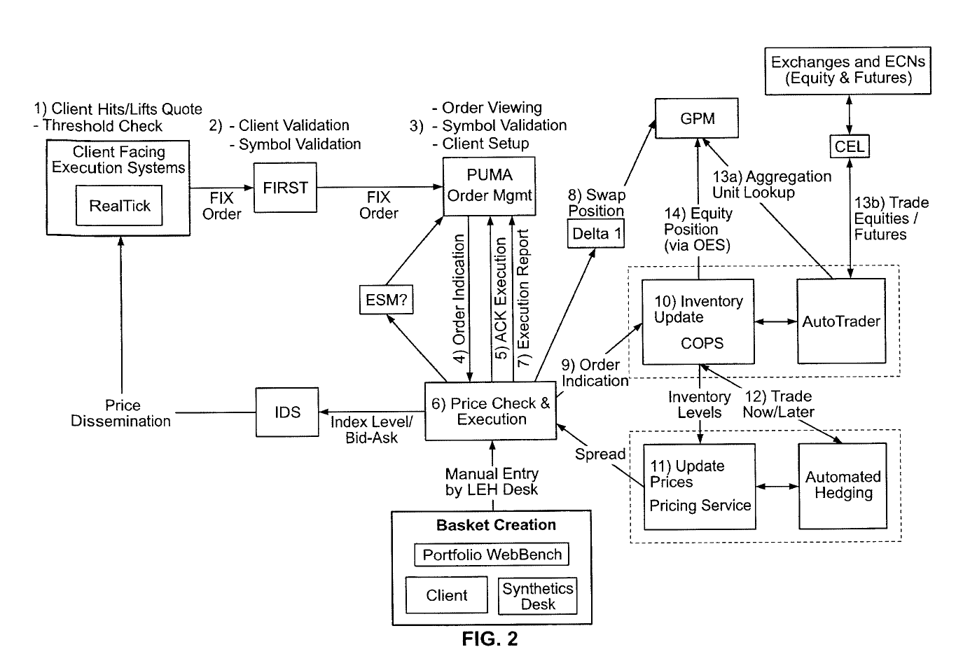

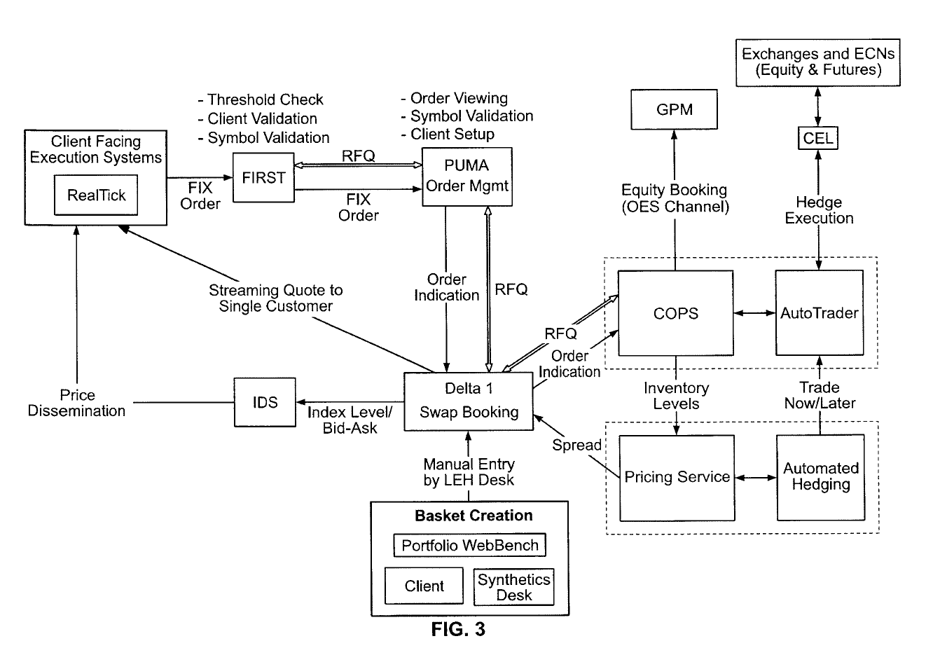

FIG. 1 depicts architecture of an embodiment. The description below describes an exemplary hedging process of an embodiment, that takes inventory into account. An embodiment also may use one or more of the methods and systems for estimating trade execution costs disclosed in U.S. patent application Ser. No. 09/704,740 (now U.S. Pat. No. 7,110,974), Ser. No. 11/497,960 (both entitled “Tool for Estimating Cost of a Trade”), and Ser. No. 11/770,205 (entitled “Methods and Systems for Estimating Trade Cost”). The entire contents of each of these three applications are incorporated herein by reference. Those skilled in the art will recognize that other embodiments may use other known trade cost estimation methods without departing from the scope of the invention described herein.

Regarding FIG. 1, the following terms are used:

FIRST—is an inbound FIX gateway with an entitlements system used to check inbound customer trade flow against limits, and to route orders to the correct Order Management System (“OMS”) based on the type of flow.

PUMA—is an internal OMS preferably primarily used to handle program trades, but may also handle, for example, single stock and swap flows.

ESM—is an Enterprise Security Master, a database of securities across asset classes that includes core pieces of information—e.g., symbol, CUSIP number, dividends, and maturity dates.

IDS—is an Inventory Distribution System, used to take price feeds from internal OMSs and distribute them to third parties like Bloomberg, Reuters, RealTick, etc.

Delta1—is an internal system preferably used to maintain the constituents of basket swaps, as well as to book and record swap transactions done with clients.

COPS—is an inventory maintenance system that receives real-time transactions as client swaps are entered, so that exposure can be monitored and real-time hedging can occur.

GPM—is a Global Position Monitor, a real-time risk-management system used by trading management. It tracks real-time P&L and positions across a division.

CEL—is a Common Exchange Layer, a framework that houses connectivity to exchanges and liquidity centers like Eons, etc.

In an embodiment, the exemplary system depicted in FIG. 1 preferably functions as follows:

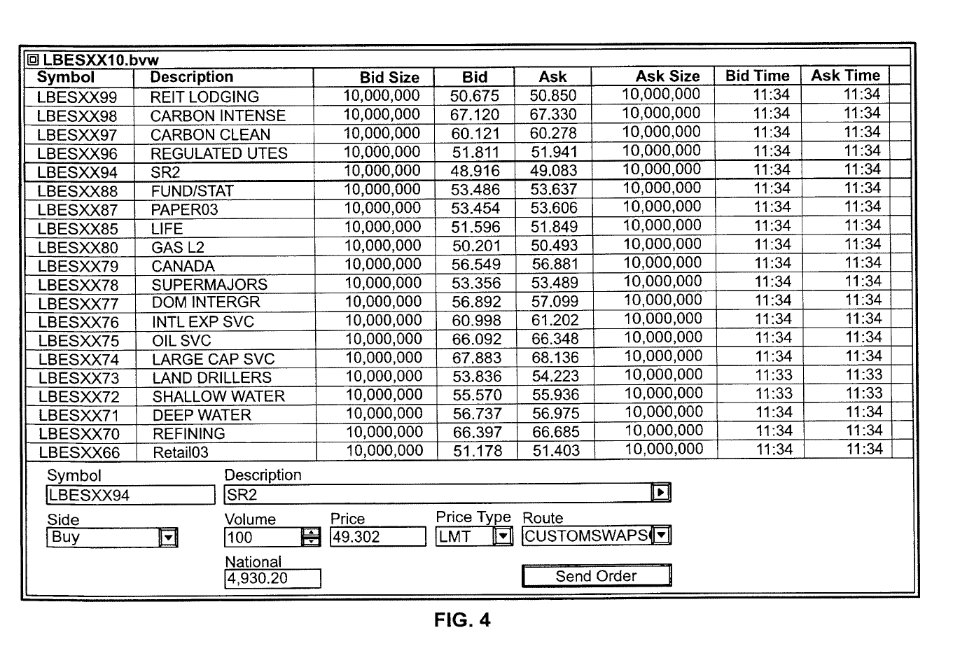

Assume that initially there is no inventory. Starting at component 110, a client preferably utilizes a Portfolio WebBench (or other portfolio management interface) in conjunction with a Synthetics Desk to create a custom basket as a hedge to their portfolio—“Basket Creation.” This process may include, for example, a customer taking a listed ETF (exchange traded fund) basket that closely tracks a portfolio they own, and then removing from that basket names where they think they have real alpha.¹ Those names are then replaced with other names to bring the now custom basket to an acceptable level of tracking error. FIG. 4 depicts an exemplary data and order entry screen used in an embodiment. The spread reflects deflection based on current inventory. ¹ Alpha is a measurement used in modern portfolio theory (others are beta, standard deviation, R-squared, and Sharpe ratio). Alpha is often said to represent the value that a portfolio manager adds to or subtracts from a portfolio's return. An alpha of 1.0 means a portfolio has outperformed its benchmark index by 1%; an alpha of −1.0 indicates an underperformance of 1%.

That basket is then loaded into Delta1 116—where the index level is struck to some base level agreed upon with the client—say “100,” for example. Delta1 will place a standard spread around that level where a market maker will buy and sell a basket of, say, $10 mm notional.

Moving clockwise in FIG. 1 from Delta1:

Delta1 passes the bid/offer price to IDS 120, which passes it to RT 125. RT displays the prices for the basket, and allows the client to trade via an Electronic Order Ticket. Orders are sent from RT through a front end gateway—FIRST 130. FIRST 130 will make sure the core pieces of information are on the order, and pass it to PUMA 135.

PUMA will validate the symbol to ensure that it's known by Delta1 (by referencing ESM 140, which contains a universe of Custom Swaps as part of a library of over 40,000 traded securities. PUMA allows salespeople to see the orders coming in, and passes the order onto Delta1 116.

After confirming that the price on the order is within an acceptable range from the current price known by Delta1, Delta1 will acknowledge the order and send a fill report back to the client. Upon the order being accepted, the swap trade is sent to GPM 150. This is a risk management platform. Exposure is then shown. Additionally, the swap trade is sent to COPS 155, which will now reflect an off-setting long/short position in the appropriate number of shares for the stocks in the basket.

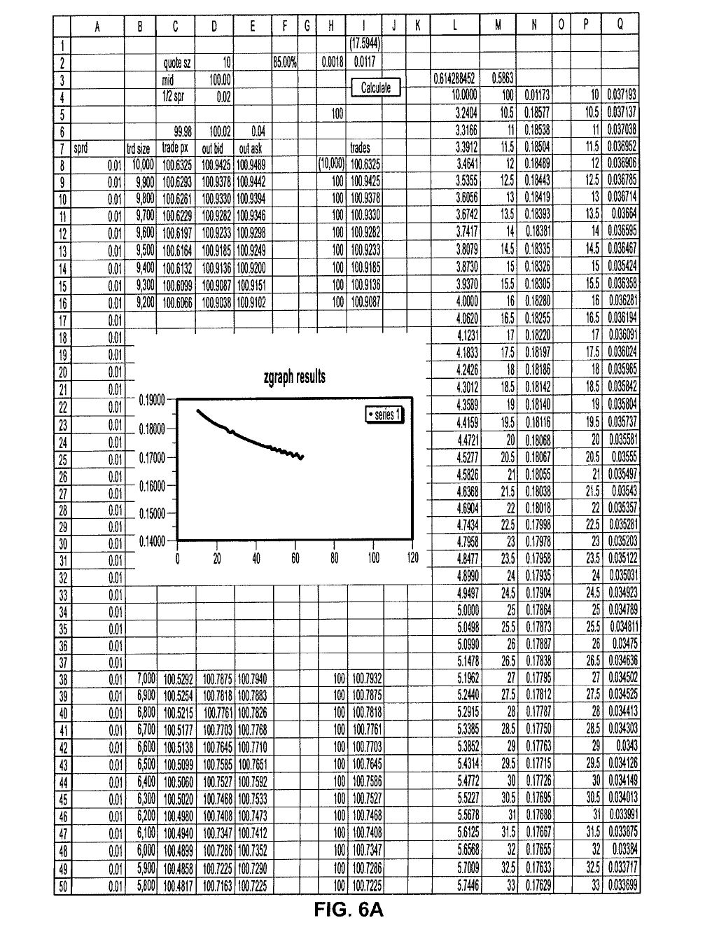

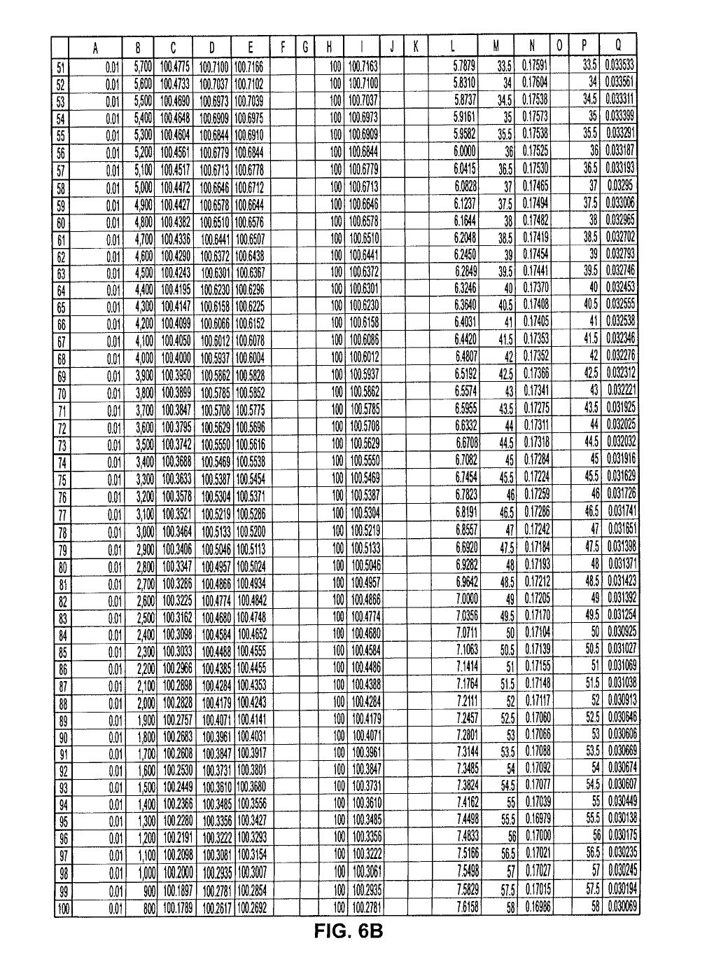

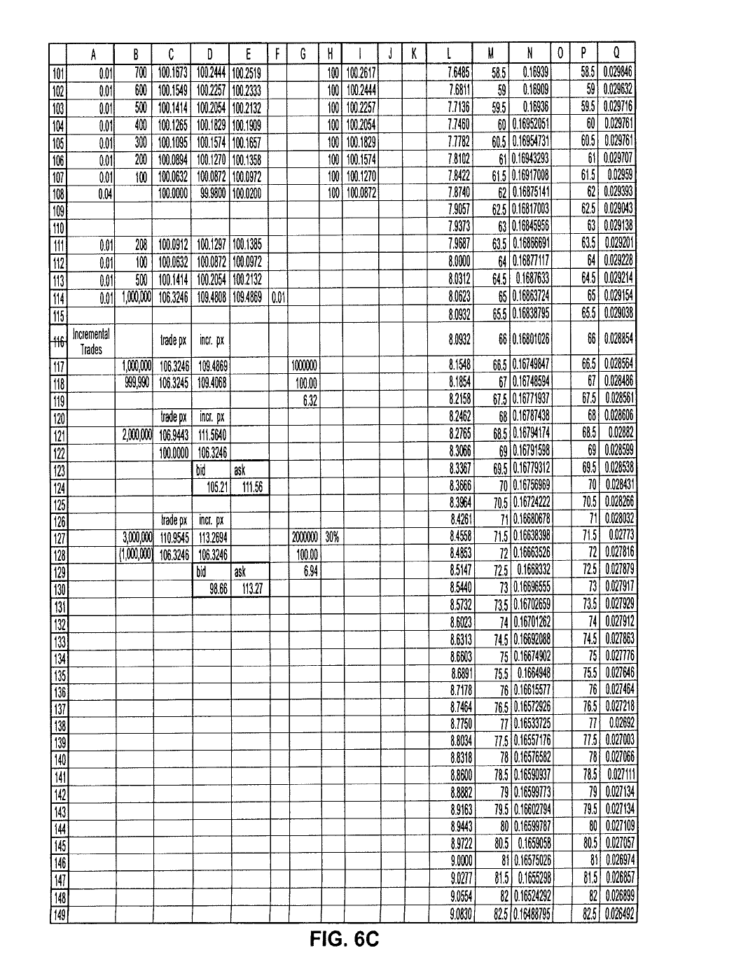

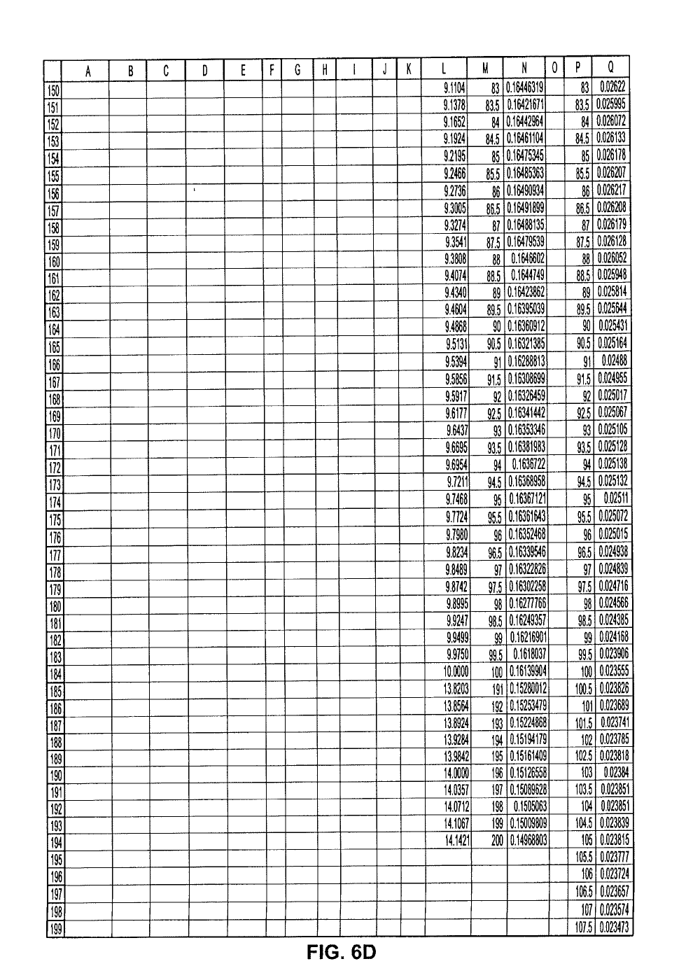

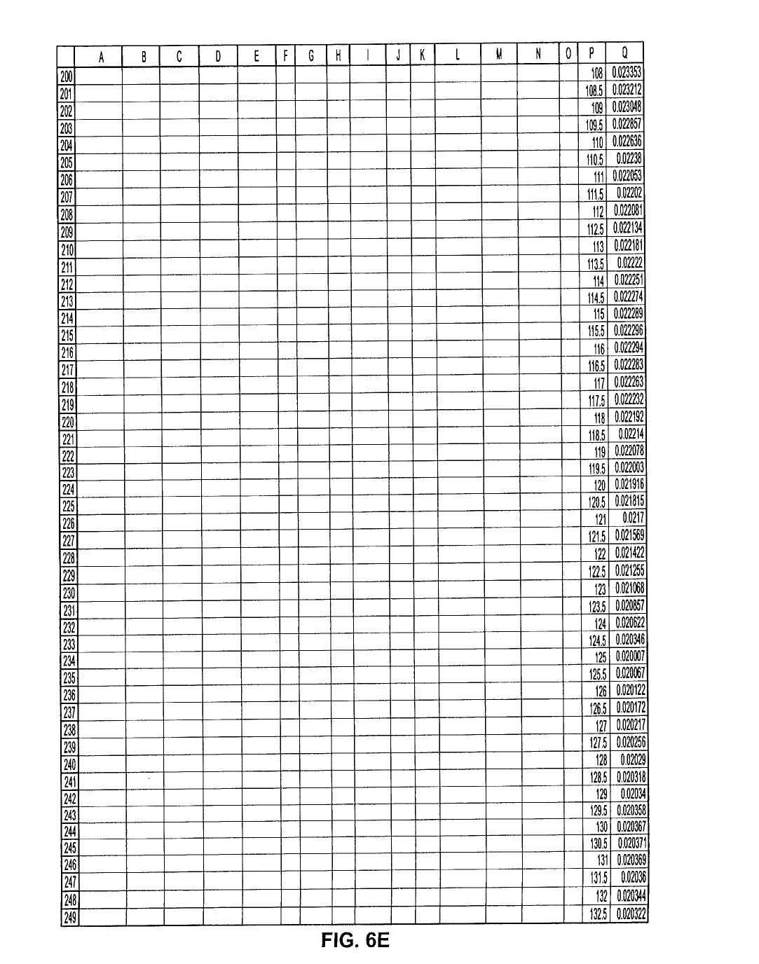

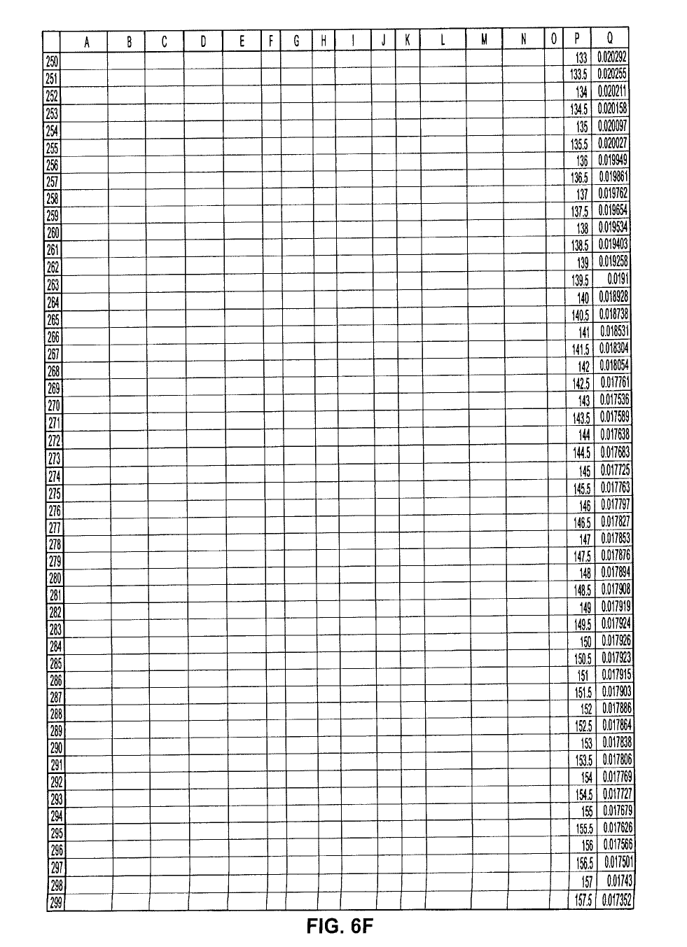

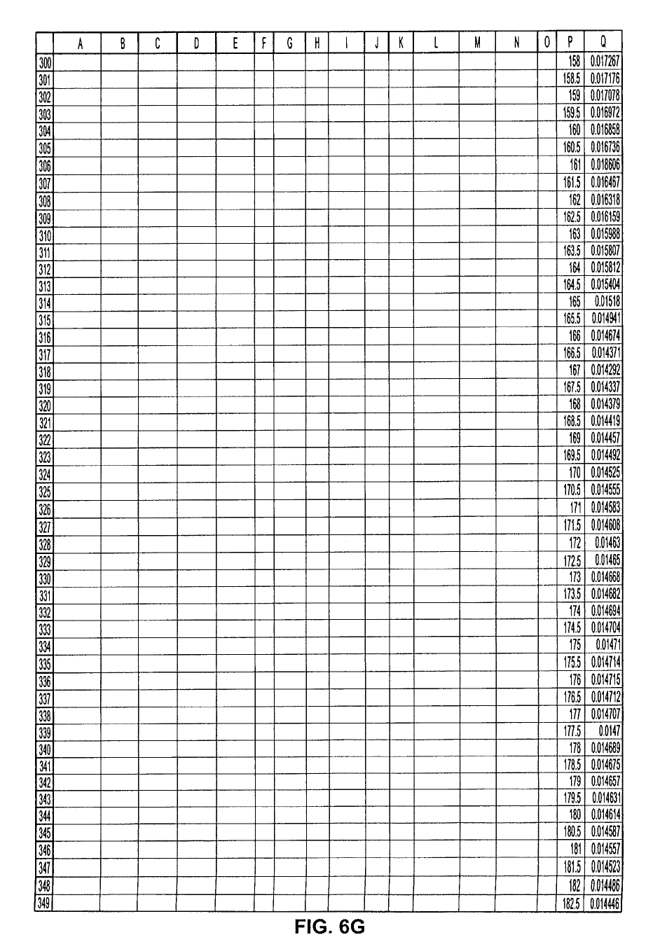

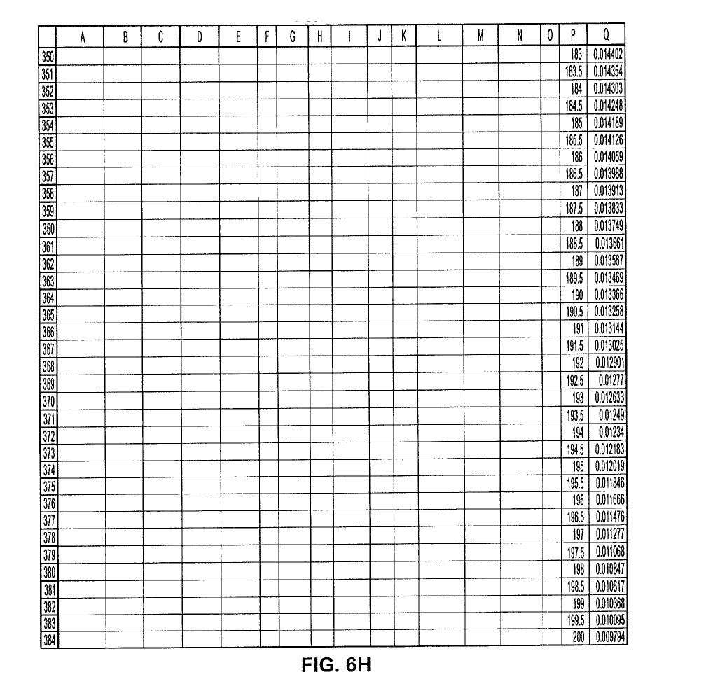

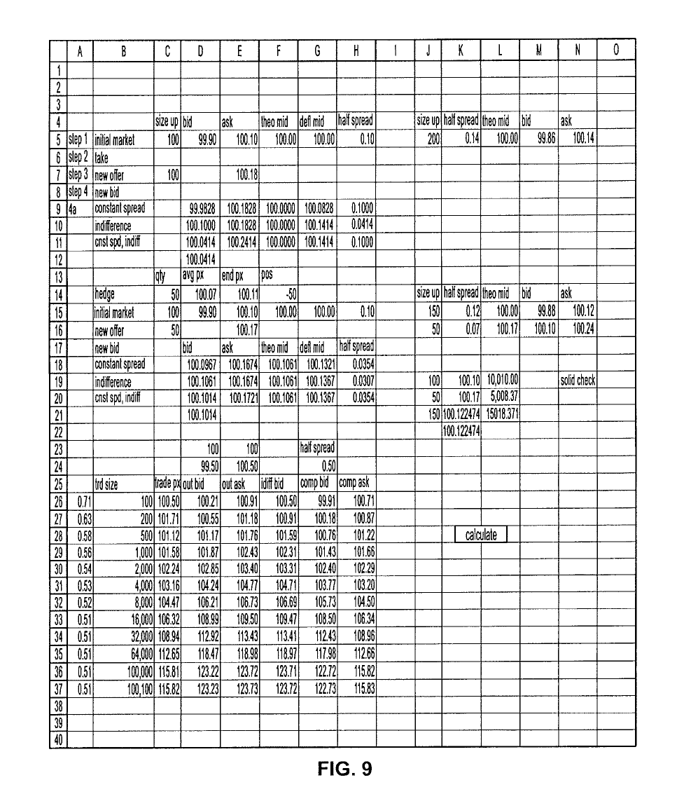

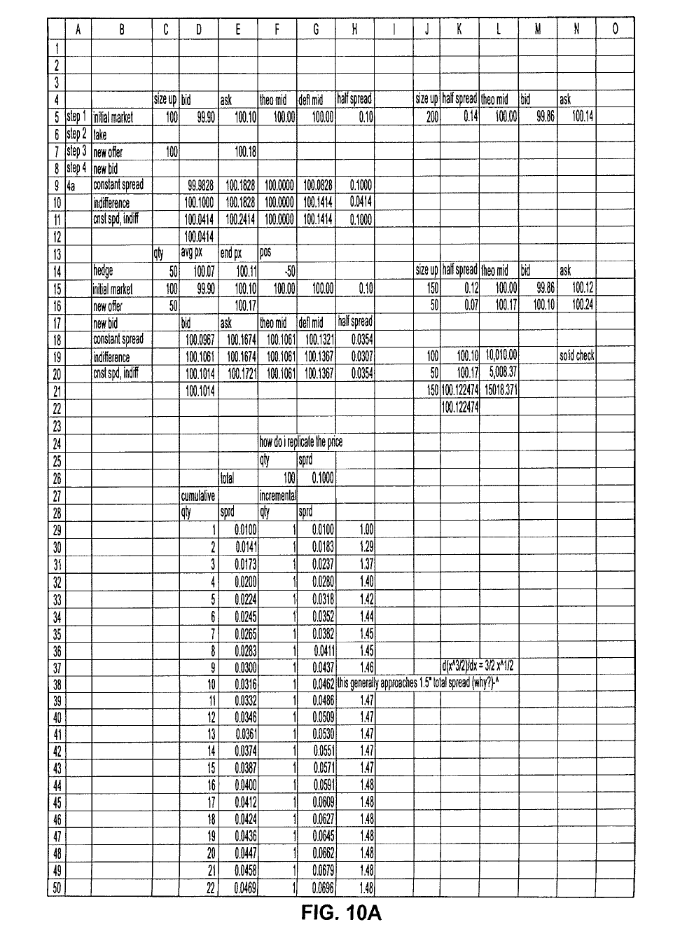

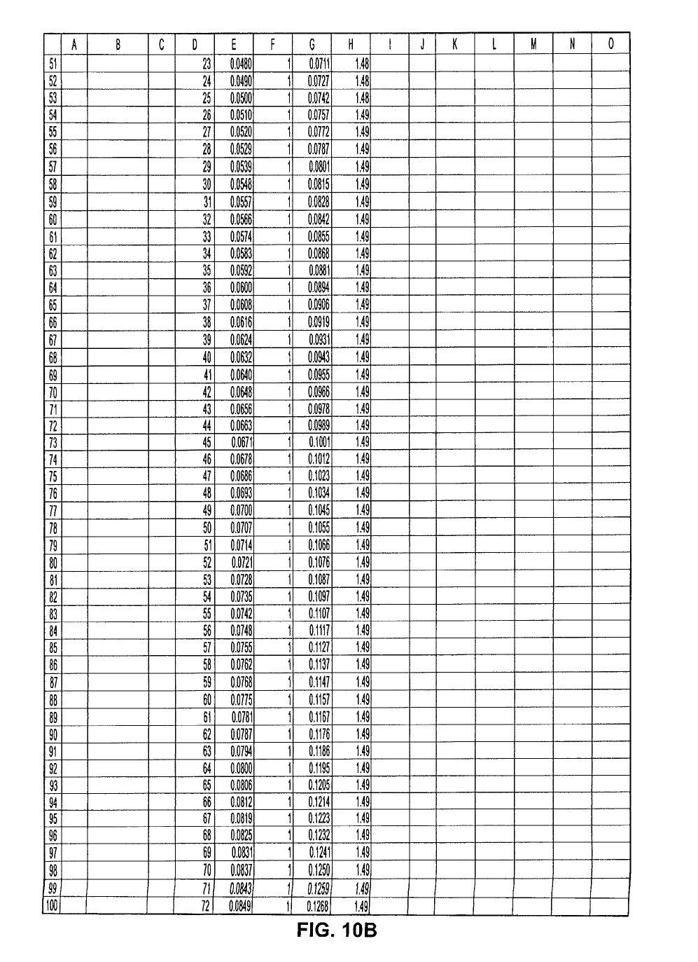

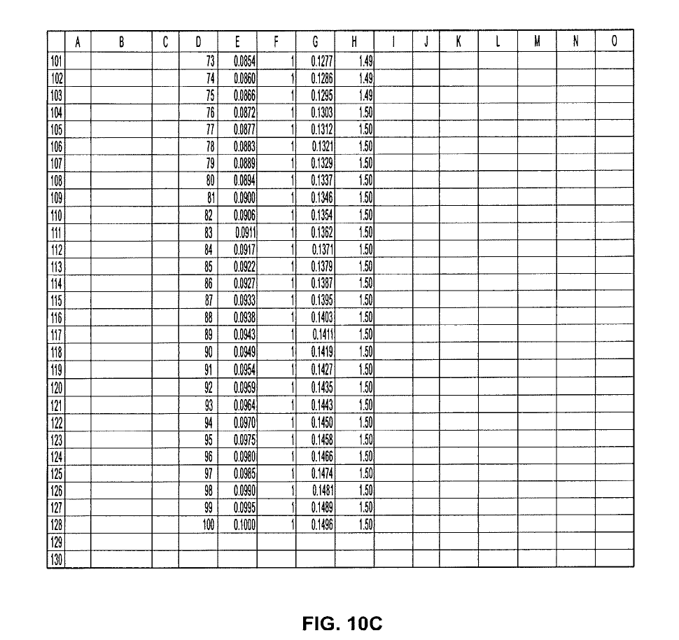

Based on the new inventory level, a Pricing Service 160 will deflect quotes—as the market maker becomes more exposed, markets widen, and as exposure is covered, the spread will tighten. See the discussion below and the spreadsheet pages depicted in FIGS. 6A-10C (which illustrate the calculations described therein) for details on quote deflection.

An automated hedge program 165 looks at the inventory, and will send electronic messages of what to trade and when to reduce exposure. These messages are sent to the AutoTrader 170 for execution. The orders preferably go to market 190 via CEL 180 (an exchange connectivity layer).

As the hedge orders begin to be executed, the executions will flow back into COPS 155 to show reduced inventory (this in turn triggers the pricing service 160 to adjust the spread that Delta1 116 will apply). They will also flow to GPM 150 to reflect the hedge and show less risk. Preferred hedging models are discussed below, but those skilled in the art will recognize that other hedging models could be used in this context without departing from the scope of the present invention.

Inventory Pricing Model of an Embodiment

Define a function MMP(A|I) that represents a fair value price for a new trade in the presence of a market maker's current inventory: A=new trade; I=existing market maker inventory.

The “no arbitrage” principle requires that MMP satisfies the following conditions:

MMP(I+A|0)=MMP(I|0)+MMP (A|I)

MMP(I−A|0)=MMP(I|0)+MMP (−A|I)

A market maker's ask and bid prices can be represented as:

Ask=MMP(A|I); Bid=−MMP(−A|I).

Spread (A|I)=[MMP(A|I)+MMP(−A|I]/Size (A)

Deconstructing the Pricing Function

MMP should reflect the economic utility of the market maker:
The cost of unwinding the trade in the inter-dealer market against other market makers: Cost (x)
The risk of maintaining inventory positions: Risk (x)

While various combinations are possible and will be recognized by those skilled in the art, in an embodiment we represent MMP(x) as a simple sum of the cost and risk components:
MMP(x)=Cost (x)+λRisk (x), where λ represents the risk aversion parameter of the market maker.

The Cost term preferably is estimated using market impact models described in U.S. patent application Pub. Ser. No. 09/704,740 (now U.S. Pat. No. 7,110,974); Ser. No. 11/497,960 (Pub. No. 2006/0271469); and Ser. No. 11/770,205, to Zhang et al. (entitled “Methods and Systems for Estimating Trade Cost”). All three applications are incorporated herein by reference, as noted above. However, those skilled in the art will recognize that other market impact models known in the art may be used in this context without deviating from the scope and spirit of the present invention.

The Risk term is dictated by the volatility of the market maker's inventory.

Analysis of Preferred Inventory Pricing Model

The spread depends on the correlation between Inventory I and new trade A. While one side can be aggressive, to limit the inventory from growing too large, the other side can be conservative due to convexity effect:

Example: Market Making for a Single Name

I: IBM 10,000 shares; A: IBM 2,000 shares. IBM's current mid price is $100. We use the notation <bid, ask>.
Quote for I: 10,000 shares is <100−0.10, 100+0.10> per share.
Quote for I+A: 12,000 shares is <100−0.1095, 100+0.1095> per share.
Quote for I−A: 8,000 shares is <100−0.0894, 100+0.0894> per share.
Quote for A: 2000 shares is <100−0.047, 100+0.047> per share.

From our pricing model, a quote for 2,000 shares of IBM in the presence of inventory of 10,000 shares is <100+0.1027, 100+0.157> per share, as shown below.

Calculations:

MMP (I+A|0)=12000*0.1095

MMP (I−A|0)=8000*0.0894

MMP(I|0)=10000*0.1
Full spread for 2000 shares at zero inventory (Spread(A|0)) is 0.094/share.

Thus,

MMP(A|I)=2000*0.157

MMP(−A|I)=−2000 *0.1424

These calculations give rise to the quote of <100+0.1027, 100+0.157> per share for 2000 shares.

Extension of Inventory Pricing Model
Downward Shift

A downward shift may be used to improve bid/ask pricing. This preferably is implemented via the following: (a) a trader can shift residual risk exposure from 0 to a level L. As a result, it reduces the “effective inventory” to I′; (b) for a convex curve: price=f(X), where X is a basket to be priced; (c) if 0 is a targeted residual risk, then f′(I) may be used to estimate: MMP(A|I)=f′(I)/f′(0)*MMP(A|0); and (d) by scaling effective inventory from I to I′, we use MMP(A|I)=f′(I)/f′(0)*MMP(A|0); I′<I. This improves the quote since it limits the penalty associated with a large level of inventory risk.
Alpha Adjustment

Alpha adjustment also may be used to improve the model. Preferably, this adjustment is: (a) based on a trader's observed trading prowess; (b) directional; and (c) Adj (bps)=a*horizon/10,000.

Example: When a zero-alpha market is <100.04, 100.18>, if the alpha adjustment is 6 bps, then the market becomes <100.10, 100.24>.
Skew Ratio

A skew ratio Φ(I) may be used to adjust the bid/offer spread. One side is used to subsidize the other side. To illustrate: say that P_{mid} is the mid price of the basket. Prior to adjustment, the <bid, ask> is: <P_{mid}−S_{b}, P_{mid}+Sₐ>, where S_{b}=P_{mid}−bid, and Sₐ=ask−P_{mid}. Let S₀ be the maximum reward or penalty.

We adjust <bid, ask> as follows:
When S_{b}>>Sₐ, S′_{b}=S_{b}−S₀*Φ(I) and S′ₐ=Sₐ+S₀*Φ(I), where S′_{b} and S′ₐ, are the adjusted values for S_{b} and Sₐ, respectively. When Sₐ>>S_{b},=S_{b}+S₀*Φ(I) & S′ₐ=Sₐ−S₀*Φ(I).

This allows a trader to choose a point from a range defined by two extreme cases: (a) the price of a stand-alone basket: <P_{mid}−Sₐₗₒₙₑ, P_{mid}+Sₐₗₒₙₑ>; and (b) an unadjusted quote: <P_{mid}−S_{b}, P_{mid}+Sₐ> in the presence of inventory.

The key regarding preferred pricing model extensions is to provide flexibility to a trader: (a) the trader sets the allowed residual inventory risk level; (b) the trader adjusts for “alpha” to reflect observed trading prowess; and (c) the trader sets a skew ratio, to shape the bid/ask distribution.

Anatomy of Inventory Effects

One goal of the subject systems and methods if to provide a methodology to derive a price for a new trade in the presence of inventory, from <P_{mid}−Sₐₗₒₙₑ, P_{mid}+Sₐₗₒₙₑ> for new trade A with no inventory and adjustment terms from Inventory I and new trade A.

In an embodiment, the systems and methods take into account the following effects:
Crossing effect (+): This results from a reservoir for order crossing and internalization. It may be order specific, or statistic distribution specific (large number law).
Risk pooling effect (+): This is based on correlation, as well as common risk hedging and diversification.
Impact convexity effect (−): Impact ratio per unit increases: the δ²/δ²I operator is positive.

Crossing effect calculations are based on order crossing and internalization. Given I as an inventory and A as a new order, the crossing effect function χ is such that

χ(I, A): [0, 1].

This function can be evaluated dynamically (i.e., order specific) or based on trader input (which typically comes from historical measurement).

Given a basket A, we get a scaled down basket A′:

A′=χ(I, A)*A.

Risk pooling effect is calculated based on:
(1) a correlation function Corr (I, A) of [−1, 1].

Case 1: Corr(I, A)>0;

Case II: Corr(I, A)<0 (risk offsetting).
(2) common risk hedging; and
(3) specific risk diluting.

We preferably calculate risk scaling factors as follows:

π₁=risk(I+A)/[risk(I)+risk(A)] for bid A

π₂=risk(I−A)/[risk(I)+risk(−A)] for offer A

Impact convexity effect:
Impact ratio per unit increases: the δ²/δ²I operator is positive.
To measure the cost of trading A with Inventory I:

In $ terms: Cost(A|I)=[Cost(I+A)−Cost(I)]

and

Cost(−A|I)=[Cost(I+(−A))−Cost(I)].

In terms of basis point (bps),

when bidding A: Ψ(I, A)=max([Cost(I+A)−Cost(I)]/A, 0);

when offering A: Ψ(1, −A)=max([Cost(I−A)−Cost(I)]/A, 0).

We define penalty ratios Φ as follows (they can be greater than 1):

Φ₁(I)=Ψ(I, A)/Cost (A)

and

Φ₂(I)=Ψ(I, −A)/Cost (−A),

and derive analytical functions of I & volatility (I), independent of A (i.e., the new trade). We then preferably adjust the swap spread with these penalty ratios.

Risk boundary effect:
A ladder increasing function λ preferably is used for risk aversion:

λ=f(Risk(I)).

An embodiment uses an inventory-adjusted risk coefficient to price a new trade.

Liquidity boundary effect:
When the PRISE model is used for pricing, the impact coefficient preferably is adjusted when the size hits a turn-over limit. The adjustment preferably is on a per-name basis, to identify “black sheep” with poor liquidity.

Trade flow modulation effect:
The question here is what position belongs to Inventory, for a synthetic equity swap, and what position doesn't? Only a portion of swap positions contributes to Inventory effect, particularly the Size Impact for a new trade. The rest (of which their risk has been compensated) should not penalize the new trade on the basis of Size Impact. For example, positions of “short a swap” and “long a fully replicated equity basket” will not contribute to the Size Impact for a new trade.

Mixing all Inventory Effects
Step 1: Adjust a new swap basket due to crossing;
Step 2: Adjust a risk aversion ratio due to inventory risk skew;
Step 3: Price a new swap, on a stand-alone basis;
Step 4: Adjust the price, in the presence of Inventory.

Basic Pricing Model

In an embodiment, the basic pricing model comprises: (a) pricing a swap on a stand-alone basis; (b) a replication model; and (c) a two-phase hedging model. Pricing on a stand-alone basis is discussed above.

A Replication Model of an embodiment (which models replicating an equity swap basket) comprises (1) buying or selling an exact same number of shares in the basket; and (2) determining an optimal trading trajectory to achieve a minimum cost.

The price from the replication model establishes a conservative price:

Price=Market Impact+Replication Risk*Risk Aversion

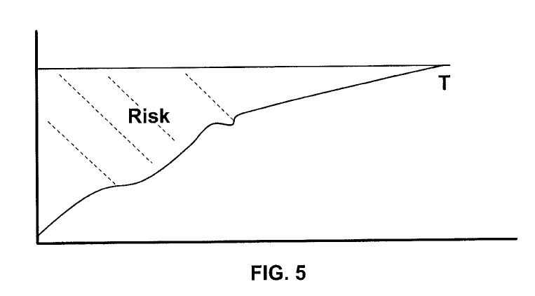

Replication Risk is modeled during the time of replication. A Risk Aversion parameter is used to charge a premium for the amount of residual risk before the completion of replication. See FIG. 5, which illustrates reduction of risk over time, measured from an initial trade.

A Two-phase Hedging Model of an embodiment comprises using Futures/ETFs to hedge the swap. We call this “Transit Hedge.” “Transit Hedge” is to reduce market risk. By reducing risk, we trade slower to lower impact in replication. It changes the trade-off dynamics between risk and cost. Preferably, a long-term hedge basket is constructed via a Replication Hedge (to reduce tracking risk).

The price for entering a synthetic equity swap covers:

1. Cost for establishing Transit Hedge positions;

2. Cost for establishing Replication Hedge;

3. Compensation for the risk premium during hedging; and

4. Cost for unwinding Transit Hedge positions.

Funding gain covers the residual risk while holding an equity swap.

This also gives recipe for trading. By following that recipe, the market maker covers costs.

The spreadsheets depicted in FIGS. 6-10 illustrate the formulas and calculations used by software operating on computers as described above, and further illustrate the concept of market deflection. “Deflection” refers to the following problem. Assume the theoretical price to be 100. A market can be made around that price, but the mid-price would be the “theoretical” mid. As soon as a market maker acquires inventory (e.g., the market maker sells 100 shares at 100.20), the market maker needs to deflect his market to reflect his inventory. Because he sold, he's now a more eager buyer, and would pay more to cover his risks (e.g., instead of 99.80, he might pay 99.98)—but if he had to sell more, he would have to sell it at a price higher than 100.20 (because of the additional risk). Thus, because of his particular inventory, his market (the prices at which he's willing to buy and sell) has been deflected upward. The question is how to determine precisely how much a market has been deflected, given a particular inventory.

The following informal discussion highlights exemplary portions of the spreadsheets.

In the spreadsheet depicted in FIGS. 6A-6H:

First, there is a default quote size (D-2) and spread for that size. Then there is an initial trade size (B-8) and a calculated price for that trade. Next, there is an “out” market for the default quote size. Finally, inventory is decremented as bids are hit. After each transaction, the new out market is calculated.

Initial Block Trade size can't be bigger than 100× default quote size. (F-2) is the deflection, set by the trader; [I-1] is the total P&L of the trade; and [I-2] is the scaled P&L of the trade.

Thus, FIG. 6 shows how inventory reacts to initial trades and how prices perpetually deflect.

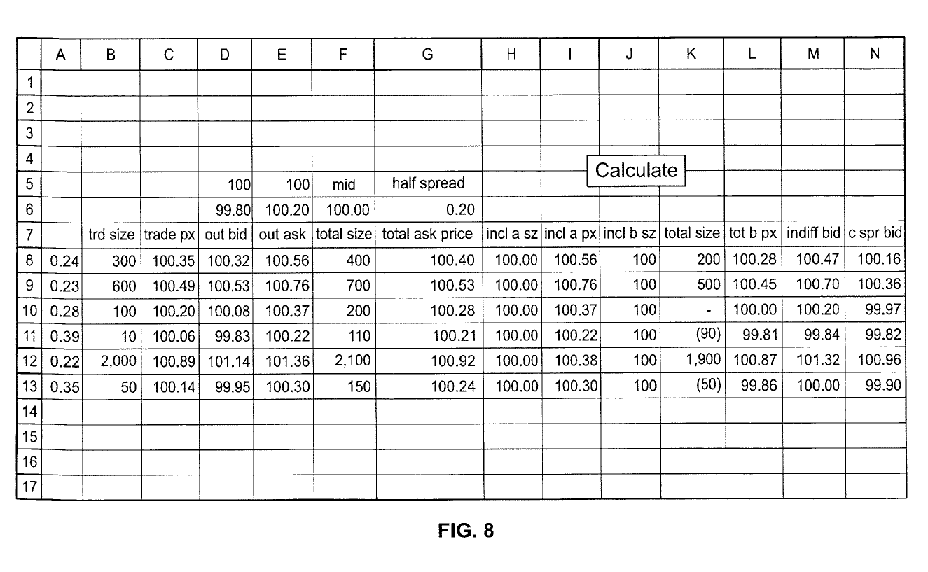

FIGS. 8, 9, and 10 show steps involved in producing the data depicted in FIGS. 6A-6H.

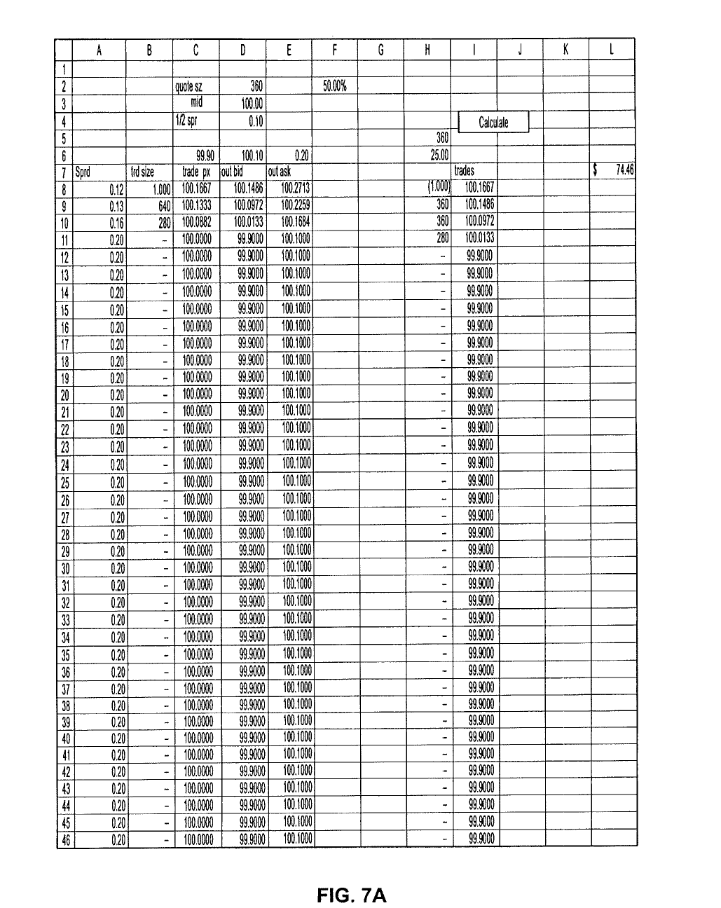

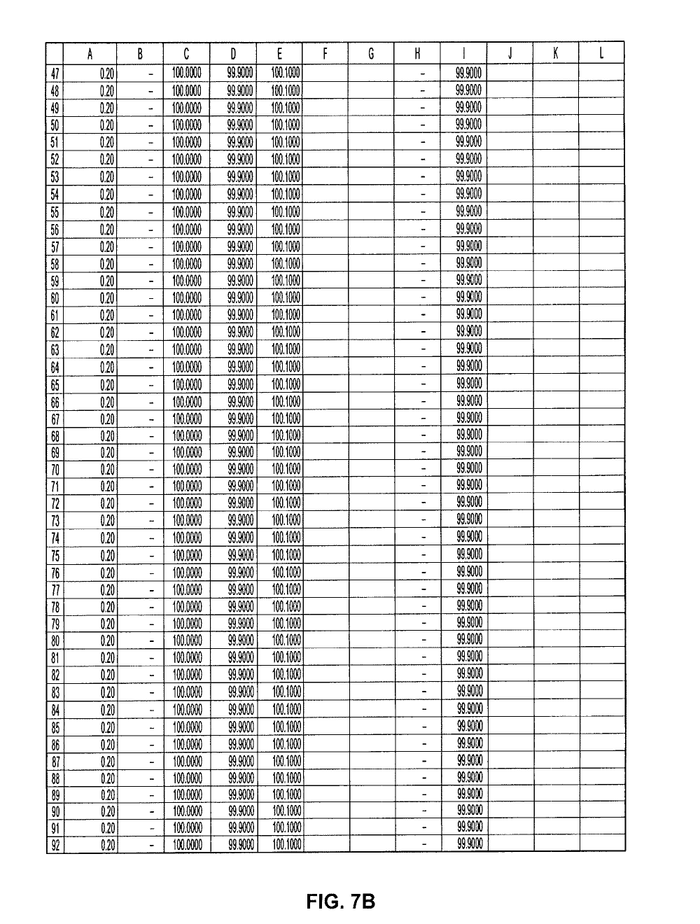

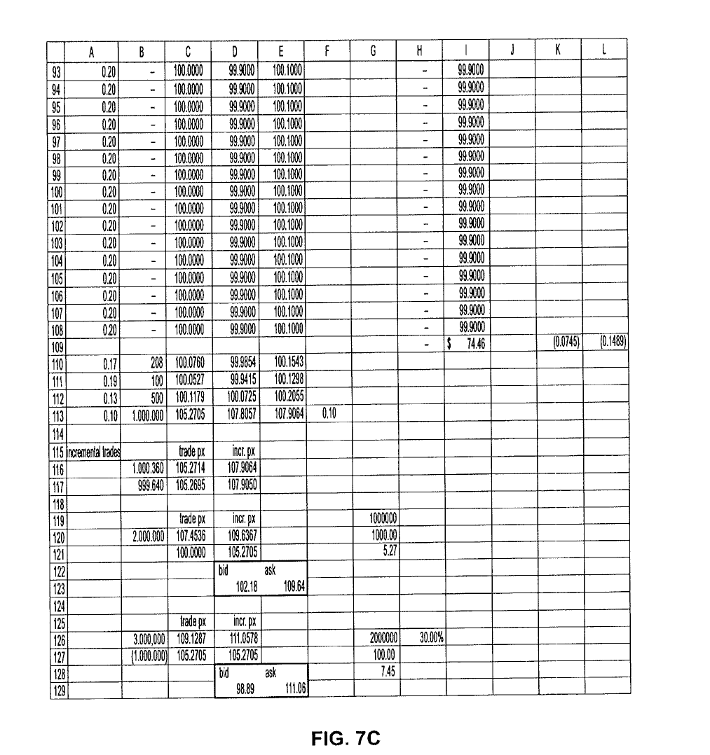

FIG. 7 depicts a second illustrative calculation using a different quote size, a wider spread, and a different initial trade size. In this case, the net profit is $74.46 (see cell I-109).

Referring to FIG. 8: shown is an initial market, which is in D5 through E6, and which is basically 99.80 to 100.20, 100 up. The half spread between bid and offer is 20¢. In column B, there are various trade sizes. Column C says, if the market maker (“MM”) is making its market at 100 up, 99.80 to 100.20, MM would trade (see row 10), 100 at 100.20. If a buyer bought 300, MM would trade it at 100.35. Then, for the out ask, if MM trades 100 shares at 100.56, and 300 shares at 100.35, then net, M traded 400 shares at 100.40.

After the trade price for the size is found, the offer on the next 100 shares after that trade is calculated. The indifference bid2 in cell M8 is as follows: MM already sold 300 shares; MM would sell 200 shares (the size in K8), the price for that (in L8) would be 100.28. Thus, if MM knows that MM would sell 200 at 100.28, and MM already sold 300 at 100.32, there is a price at which MM would be indifferent to such a trade. If MM paid 100.47 for 100 and sold 300 at 100.35, MM's net transaction is as if MM sold 200 at 100.28. Now, if MM did that, MM would not make any money and would not be compensated for taking the risks of a market maker. So the question is how far MM moves down. MM's out ask is strictly defined (100.56). The bid is somewhere between 100.16 and the indifference bid, which is 100.47. ² An indifference bid is the price at which there is no risk but also no profit for the market maker.

What the trader controls is what portion of the spread between the full spread and the indifference spread the trader wants to keep in return for providing liquidity. What the spreadsheets show is that it can make sense to sell at one price and then immediately buy a smaller quantity at a higher price.

It will be appreciated by those skilled in the art that the present invention has been described by way of example only, and that the invention is not to be limited by the specific embodiments described herein. Improvements and modifications may be made to the invention without departing from the scope or spirit thereof.

Embodiments of the present invention comprise computer components and computer-implemented steps that will be apparent to those skilled in the art. For example, calculations and communications as described above can be and in embodiments are intended to be performed electronically. While, for ease of exposition, not every step or element of the present invention is described herein as part of a computer system, those skilled in the art will recognize that each step or element described and/or claimed herein may have a corresponding computer system or software component. Such computer system and/or software components are clearly, to those skilled in the art, enabled by describing their corresponding steps or elements (that is, their functionality), and are within the scope of the present invention.

We claim:

1. A computer system for market making, comprising:
a computer component for receiving data identifying a user-specified basket of securities;
a database storing said data identifying a user-specified basket of securities and storing data describing inventory of a market maker; and
a computer component for calculating a swap price for said basket in light of said inventory, said calculating based at least in part on quote deflection related to said inventory.

2. A computer system as in claim 1, further comprising a computer component in communication with an electronic swap trading system.

3. A computer system as in claim 1, wherein said computer component for calculating a swap price is further operable to calculate a spread associated with said swap price.

4. A computer system as in claim 3, wherein said spread changes based at least in part on changes in said inventory.

5. A computer system as in claim 1, wherein said swap price is based at least in part on a sum of a cost component and a product of a risk component and a risk aversion parameter.

6. A computer system as in claim 5, wherein said cost component corresponds to a cost of unwinding a swap of said basket in a market.

7. A computer system as in claim 5, wherein said risk component corresponds to risk of maintaining a position in said inventory.

8. A computer system as in claim 5, wherein said cost component is estimated using a market impact model.

9. A computer system as in claim 5, wherein said cost component is calculated based at least in part on volatility of said inventory.

10. A computer system as in claim 3, wherein said price and spread are calculated based at least in part on a correlation between said inventory and said basket.

11. A computer system as in claim 3, wherein said price and spread are calculated based at least in part on downward shift in effective inventory.

12. A computer system as in claim 3, wherein said price and spread are calculated based at least in part on alpha adjustment.

13. A computer system as in claim 12, wherein said alpha adjustment is based at least in part on a trader's performance.

14. A computer system as in claim 12, wherein said alpha adjustment is directional.

15. A computer system as in claim 12, wherein said alpha adjustment is proportional to a horizon.

16. A computer system as in claim 3, wherein said price and spread are calculated based at least in part on a skew ratio.

17. A computer system as in claim 3, wherein said price and spread are calculated based at least in part on an allowed residual inventory risk level.

18. A computer system as in claim 3, wherein said price and spread are calculated based at least in part on a crossing effect.

19. A computer system as in claim 3, wherein said price and spread are calculated based at least in part on a risk pooling effect.

20. A computer system as in claim 3, wherein said price and spread are calculated based at least in part on an impact convexity effect.

21. A computer system as in claim 3, wherein said price and spread are calculated based at least in part on a risk boundary effect.

22. A computer system as in claim 3, wherein said price and spread are calculated based at least in part on a liquidity boundary effect.

23. A computer system as in claim 3, wherein said price and spread are calculated based at least in part on a trade flow modulation effect.

24. A computer system as in claim 3, wherein said computer component for calculating a swap price is further operable to calculate said price and spread based at least in part on:
(a) adjusting a new swap basket due to crossing;
(b) adjusting a risk aversion ratio due to inventory risk skew;
(c) pricing said swap on a stand-alone-basis; and
(d) adjusting a price of said swap based on said inventory.

25. A computer system as in claim 3, wherein said computer component for calculating a swap price is further operable to calculate said price and spread based at least in part on:
(a) pricing a swap on a stand-alone basis;
(b) a replication model; and
(c) a hedging model.

26. A computer system as in claim 25, wherein said replication model models replicating an equity swap basket and comprises:
(a) buying or selling a number of shares in said basket, and
(b) determining an optimal trading trajectory to achieve a minimum cost.

27. A computer system as in claim 25, wherein said replication model is based on market impact, replication risk, and risk aversion.

28. A computer system as in claim 25, wherein said hedging model is a two-phase hedging model.

29. A computer system as in claim 28, wherein said two-phase hedging model is based on a transit hedge.

30. Software, stored in a computer-readable medium, for market making, comprising:
software for receiving data identifying a user-specified basket of securities;
software for storing said data identifying a user-specified basket of securities and storing data describing inventory of a market maker; and
software for calculating a swap price for said basket in light of said inventory, said calculating based at least in part on quote deflection related to said inventory.

31. Software as in claim 30, further comprising software in communication with an electronic swap trading system.

32. Software as in claim 30, wherein said software for calculating a swap price is further operable to calculate a spread associated with said swap price.

33. Software as in claim 32, wherein said spread changes based at least in part on changes in said inventory.

34. Software as in claim 30, wherein said swap price is based at least in part on a sum of a cost component and a product of a risk component and a risk aversion parameter.

35. Software as in claim 34, wherein said cost component corresponds to a cost of unwinding a swap of said basket in a market.

36. Software as in claim 34, wherein said risk component corresponds to risk of maintaining a position in said inventory.

37. Software as in claim 34, wherein said cost component is estimated using a market impact model.

38. Software as in claim 34, wherein said cost component is calculated based at least in part on volatility of said inventory.

39. Software as in claim 32, wherein said price and spread are calculated based at least in part on a correlation between said inventory and said basket.

40. Software as in claim 32, wherein said price and spread are calculated based at least in part on downward shift in effective inventory.

41. Software as in claim 32, wherein said price and spread are calculated based at least in part on alpha adjustment.

42. Software as in claim 41, wherein said alpha adjustment is based at least in part on a trader's performance.

43. Software as in claim 41, wherein said alpha adjustment is directional.

44. Software as in claim 41, wherein said alpha adjustment is proportional to a horizon.

45. Software as in claim 32, wherein said price and spread are calculated based at least in part on a skew ratio.

46. Software as in claim 32, wherein said price and spread are calculated based at least in part on an allowed residual inventory risk level.

47. Software as in claim 32, wherein said price and spread are calculated based at least in part on a crossing effect.

48. Software as in claim 32, wherein said price and spread are calculated based at least in part on a risk pooling effect.

49. Software as in claim 32, wherein said price and spread are calculated based at least in part on an impact convexity effect.

50. Software as in claim 32, wherein said price and spread are calculated based at least in part on a risk boundary effect.

51. Software as in claim 32, wherein said price and spread are calculated based at least in part on a liquidity boundary effect.

52. Software as in claim 32, wherein said price and spread are calculated based at least in part on a trade flow modulation effect.

53. Software as in claim 32, wherein said software for calculating a swap price is further operable to calculate said price and spread based at least in part on:
(a) adjusting a new swap basket due to crossing;
(b) adjusting a risk aversion ratio due to inventory risk skew;
(c) pricing said swap on a stand-alone-basis; and
(d) adjusting a price of said swap based on said inventory.

54. Software as in claim 32, wherein said software for calculating a swap price is further operable to calculate said price and spread based at least in part on:
(a) pricing a swap on a stand-alone basis;
(b) a replication model; and
(c) a hedging model.

55. Software as in claim 54, wherein said replication model models replicating an equity swap basket and comprises:
(a) buying or selling a number of shares in said basket, and (b) determining an optimal trading trajectory to achieve a minimum cost.

56. Software as in claim 54, wherein said replication model is based on market impact, replication risk, and risk aversion.

57. Software as in claim 54, wherein said hedging model is a two-phase hedging model.

58. Software as in claim 57, wherein said two-phase hedging model is based on a transit hedge.

59. A computer-implemented method for market making, comprising:
electronically receiving data identifying a user-specified basket of securities;
storing in an electronic database said data identifying a user-specified basket of securities and storing in said electronic database data describing inventory of a market maker; and
electronically calculating a swap price for said basket in light of said inventory, said calculating based at least in part on quote deflection related to said inventory.

60. A method as in claim 59, further communicating electronically with an electronic swap trading system.

61. A method as in claim 59, further comprising calculating a spread associated with said swap price.

62. A method as in claim 61, wherein said spread changes based at least in part on changes in said inventory.

63. A method as in claim 59, wherein said swap price is based at least in part on a sum of a cost component and a product of a risk component and a risk aversion parameter.

64. A method as in claim 63, wherein said cost component corresponds to a cost of unwinding a swap of said basket in a market.

65. A method as in claim 63, wherein said risk component corresponds to risk of maintaining a position in said inventory.

66. A method as in claim 63, wherein said cost component is estimated using a market impact model.

67. A method as in claim 63, wherein said cost component is calculated based at least in part on volatility of said inventory.

68. A method as in claim 61, wherein said price and spread are calculated based at least in part on a correlation between said inventory and said basket.

69. A method as in claim 61, wherein said price and spread are calculated based at least in part on downward shift in effective inventory.

70. A method as in claim 61, wherein said price and spread are calculated based at least in part on alpha adjustment.

71. A method as in claim 70, wherein said alpha adjustment is based at least in part on a trader's performance.

72. A method as in claim 70, wherein said alpha adjustment is directional.

73. A method as in claim 70, wherein said alpha adjustment is proportional to a horizon.

74. A method as in claim 61, wherein said price and spread are calculated based at least in part on a skew ratio.

75. A method as in claim 61, wherein said price and spread are calculated based at least in part on an allowed residual inventory risk level.

76. A method as in claim 61, wherein said price and spread are calculated based at least in part on a crossing effect.

77. A method as in claim 61, wherein said price and spread are calculated based at least in part on a risk pooling effect,

78. A method as in claim 61, wherein said price and spread are calculated based at least in part on an impact convexity effect.

79. A method as in claim 61, wherein said price and spread are calculated based at least in part on a risk boundary effect.

80. A method as in claim 61, wherein said price and spread are calculated based at least in part on a liquidity boundary effect.

81. A method as in claim 61, wherein said price and spread are calculated based at least in part on a trade flow modulation effect.

82. A method as in claim 61, further comprising calculating said price and spread based at least in part on:
(a) adjusting a new swap basket due to crossing;
(b) adjusting a risk aversion ratio due to inventory risk skew;
(c) pricing said swap on a stand-alone-basis; and
(d) adjusting a price of said swap based on said inventory.

83. A method as in claim 61, further comprising calculating said price and spread based at least in part on:
(a) pricing a swap on a stand-alone basis;
(b) a replication model; and
(c) a hedging model.

84. A method as in claim 83, wherein said replication model models replicating an equity swap basket and comprises:
(a) buying or selling a number of shares in said basket, and
(b) determining an optimal trading trajectory to achieve a minimum cost.

85. A method as in claim 83, wherein said replication model is based on market impact, replication risk, and risk aversion.

86. A method as in claim 83, wherein said hedging model is a two-phase hedging model.

87. A method as in claim 86, wherein said two-phase hedging model is based on a transit hedge.
